(19) United States
(12) Patent Application Publication
(10) Pub. No.: US 2026/0188314 A1
(43) Pub. Date: Jul. 2, 2026

(54) INFORMATION PROCESSING DEVICE AND INFORMATION PROCESSING METHOD

(71) Applicant: SONY GROUP CORPORATION, TOKYO (JP)

(72) Inventors: YUHEI TAKI, TOKYO (JP); KUNIHITO SAWAI, TOKYO (JP); MASAKI TAKASE, TOKYO (JP); AKIRA MIYASHITA, TOKYO (JP)

(21) Appl. No.: 19/129,330

(22) PCT Filed: Oct. 24, 2023
(86) PCT No.: PCT/JP2023/038266

§ 371 Date: May 13, 2025

(30) Foreign Application Priority Data
Nov. 17, 2022 (JP) 2022-183896

(51) Int. Cl. G10L 15/22

(52) U.S. Cl. CPC G10L 15/22

(57) ABSTRACT

An information processing device includes a scoring unit and an interaction control unit. The scoring unit calculates a score of a response characteristic of a user on the basis of a response history of the user in interaction with the user. The interaction control unit controls an amount of inquiry to the user in the interaction, on the basis of the score.

### FIELD

The present invention relates to an information processing device and an information processing method.

### BACKGROUND

An agent system is known that performs interaction with a user by using video or voice. The user responds to an inquiry from the system by voice or the like. Accordingly, a necessary operation can be readily performed.

### CITATION LIST

### Patent Literature

Patent Literature 1: JP 2002-099404 A

### SUMMARY

### Technical Problem

Whether the user prefers the inquiry depends on the user's personality, situation, and the like. Therefore, only setting rules in a uniform manner does not necessarily achieve comfortable interaction that the user expects.

Therefore, the present disclosure proposes an information processing device and an information processing method that enable comfortable interaction.

### Solution to Problem

According to the present disclosure, an information processing device is provided that comprises: a scoring unit that calculates a score of a response characteristic of a user based on a response history of the user in interaction with the user; and an interaction control unit that controls an amount of inquiry to the user in the interaction, based on the score. According to the present disclosure, an information processing device is provided that comprises: a data transmission unit that transmits response data from a user in interaction with the user; a data reception unit that receives a score of a response characteristic of the user calculated based on a response history of the user; and an interaction control unit that controls an amount of inquiry to the user in the interaction, based on the score. According to the present disclosure, an information processing method in which an information process of the information processing device is executed by a computer is provided.

### BRIEF DESCRIPTION OF DRAWINGS

FIG. 1 is a diagram illustrating an overview of an agent system.

FIG. 2 is a block diagram illustrating a configuration example of the agent system.

FIG. 3 is a diagram illustrating an example of interaction.

FIG. 4 is a diagram illustrating examples of an unusual event in which a user is unable to respond.

FIG. 5 is a table illustrating an example of score management.

FIG. 6 is a table illustrating an example of score management.

FIG. 7 is a table illustrating an example of score management.

FIG. 8 is a table illustrating an example of score management.

FIG. 9 is a table illustrating an example of conditions for inquiry and information presentation.

FIG. 10 is diagrams illustrating an example of inquiries to the user.

FIG. 11 is diagrams illustrating an example of information presentation to the user.

FIG. 12 is a flowchart illustrating an exemplary process procedure for scoring.

FIG. 13 is a flowchart illustrating an exemplary process procedure for restriction on interaction.

FIG. 14 is a diagram illustrating a modification of control of interaction.

FIG. 15 is a diagram illustrating an exemplary hardware configuration of an information processing device.

### DESCRIPTION OF EMBODIMENTS

Embodiments of the present disclosure will be described in detail below with reference to the drawings. In the following embodiments, the same portions are denoted by the same reference numerals, and description thereof will not be repeated.

Note that the description will be given in the following order.
[1. Overview of agent system]
[2. Configuration example of agent system]
[2-1. Client terminal]
[2-2. Server]
[3. Interaction example]
[4. Score management]
[5. Example of inquiry and information presentation]
[6. Process procedure]
[7. Modifications]
[7-1. First modification]
[7-2. Second modification]
[7-3. Third modification]
[8. Exemplary hardware configuration]
[9. Effects]

### 1. Overview of Agent System

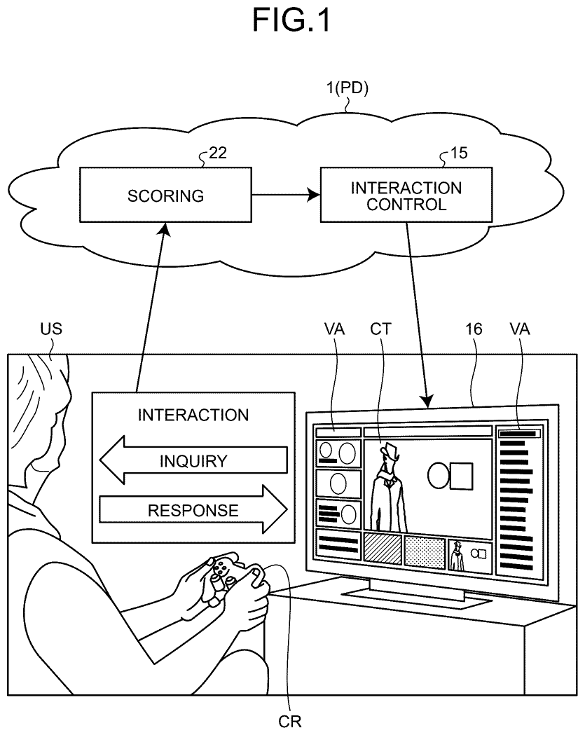

FIG. 1 is a diagram illustrating an overview of an agent system 1.

The agent system 1 performs interaction with a user US by using video or voice. In the example of FIG. 1, the agent system 1 called a dialogue agent is disclosed that receives an inquiry and request from the user US, performs information presentation for the user US, and makes an inquiry (including proposal) to the user US, through spoken dialogue.

The function of the dialogue agent is performed by a voice assistant VA. The voice assistant VA is software that combines a voice recognition technology and natural language processing to receive an input from the user US, present information for the user US, and make an inquiry to the user US. The voice assistant VA outputs a text, video, and voice to an information presentation unit 16 such as a television to perform information presentation and make an inquiry. For example, the text and video from the voice assistant VA are displayed laid over content CT being viewed by the user US.

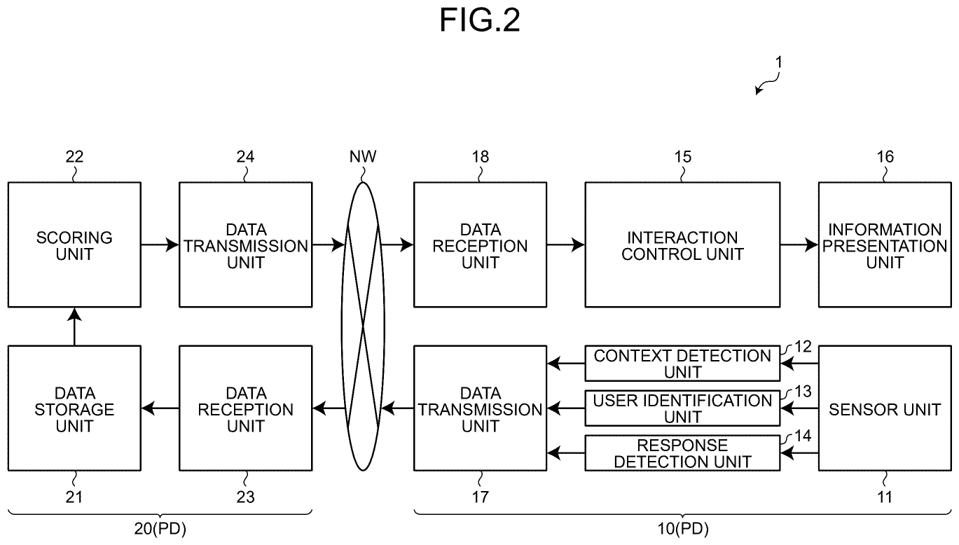

The agent system 1 may be a stand-alone system configured by a single information processing device PD, or may be a client/server system in which an agent function is distributed to a plurality of information processing devices PD (client terminal 10, server 20: see FIG. 2). In the example of the client/server system, a system developer is enabled to appropriately set whether the client terminal 10 shares which function and the server 20 shares which function.

The agent system 1 includes a scoring unit 22 and an interaction control unit 15. The agent system 1 performs interaction with the user US on the basis of dialogue via the voice assistant VA. The agent system 1 actively presents information corresponding to the user US and makes an inquiry as necessary.

The agent system 1 acquires a response from the user US to the inquiry or the information presentation by using a sensor such as a camera or a microphone. In the example of FIG. 1, the user US plays a game by using a controller CR. The agent system 1 provides related game information to the user US in a timely manner, with the progress of the game.

The agent system 1 accumulates response data from the user US sequentially acquired by the sensor. The scoring unit 22 calculates a score of a response characteristic of the user US, on the basis of a response history of the user US in the interaction with the user US. The interaction control unit 15 controls an amount of inquiry to the user US in the interaction, on the basis of the calculated score.

### 2. Configuration Example of Agent System

FIG. 2 is a block diagram illustrating a configuration example of the agent system 1.

The agent system 1 includes the client terminal 10 and the server 20. The client terminal 10 and the server 20 are connected via a network NW such as the Internet. The agent system 1 is configured as the client/server system in which the agent function is distributed to the client terminal 10 and the server 20 that function as the information processing device PD.

### 2-1. Client Terminal

The client terminal 10 performs interaction with the user US by using the voice assistant VA. The client terminal 10 acquires the response data from the user US in the interaction and transmits the response data to the server 20. The server 20 analyzes the acquired response data and scores the response characteristic of the user US. The client terminal 10 controls the interaction on the basis of a result of the scoring.

For example, the client terminal 10 includes a sensor unit 11, a context detection unit 12, a user recognition unit 13, a response detection unit 14, the interaction control unit 15, the information presentation unit 16, a data transmission unit 17, and a data reception unit 18.

### 2-1-1. Sensor Unit

The sensor unit 11 includes various sensors such as a camera, a microphone, a clock, and a fingerprint sensor. For example, the sensor unit 11 detects a video and voice of the user US by using the camera and the microphone. The sensor unit 11 detects the time by using the clock on the inside thereof. The sensor unit 11 detects a fingerprint of the user US by using the fingerprint sensor built in the controller CR. The sensor unit 11 acquires information of viewing content of the user US on the basis of operation information about the user US input to the system. The sensor unit 11 outputs the detected various information, as sensor information.

### 2-1-2. Context Detection Unit

The context detection unit 12 detects a context upon response, on the basis of the sensor information. The context detection unit 12 outputs the detected context as context information in association with the time.

The context represents a total situation and environment of the user US. When the context is different, the response characteristic of the user US differs, even if the same information, inquiry, and the like are presented. In the present disclosure, various elements that may change the response characteristic are referred to as the context. For example, the context includes a type of content CT being viewed by the user US, a type of information presented to the user US, or a time slot in which the interaction is performed.

### 2-1-3. User Recognition Unit

The user recognition unit 13 identifies the user US performing interaction with the agent system 1 on the basis of the sensor information. The user identification unit 13 outputs information of the identified user US as user identification information. For example, the user identification unit 13 is operable to identify the user US on the basis of a video of the user US captured by the camera, voice of the user US collected by the microphone, and a fingerprint of the user US acquired by the fingerprint sensor.

The agent system 1 holds individual information (face, voiceprint, fingerprint, etc.) of a registered user. The agent system 1 is configured to collate the individual information of the registered user with the user identification information to determine whether the identified user US is the registered user.

### 2-1-4. Response Detection Unit

The response detection unit 14 detects the response from the user US on the basis of the sensor information. For example, the response detection unit 14 analyzes the voice of the user US collected by the microphone to acquire a content of remarks of the user US. The response detection unit 14 analyzes the video of the user US captured by the camera to detect expression and motion (including nodding, shaking the head, eye contact, etc.) of the user US. The response detection unit 14 outputs, as the response data, verbal information extracted from the content of remarks and non-verbal information extracted from the expression and the motion, in association with the response time.

The response detection unit 14 detects a preset unusual event on the basis of the video and the voice of the user US. The unusual event means a special situation in which the user US is unable to respond. For example, when the user US leaves the seat or is on another line, the user US is unable to have an interaction. The response detection unit 14 detects such a situation as the unusual event to identify response data to be excluded from score calculation. The response detection unit 14 outputs a flag related to the presence/absence of the unusual event, in association with the response data.

### 2-1-5. Data Transmission Unit and Data Reception Unit

The data transmission unit 17 and the data reception unit 18 are connected to the network NW such as the Internet in a wired or wireless manner. The data transmission unit 17 and the data reception unit 18 transmit and receive data to and from the server 20 via the network NW.

For example, the data transmission unit 17 selectively extracts the response data from the user US identified as the registered user, on the basis of the user identification information. The data transmission unit 17 transmits the extracted response data from the user US to the server 20 together with the context information. The data reception unit 18 receives the score of the response characteristic of the user US calculated on the basis of the response history of the user US, from the server 20.

### 2-1-6. Interaction Control Unit

The interaction control unit 15 controls the interaction on the basis of the score of the response characteristic of the user US. The control of the interaction includes control of the amount of inquiry to and the amount of information provided to the user US in the interaction. The interaction control unit 15 is also configured to change timing of inquiry, timing of information provision, and the like according to the score.

The interaction control unit 15 enables restriction on the interaction on the basis of the score. The restriction on the interaction is performed by inhibiting the inquiry or information provision to the user US under a specific condition based on the score. For example, the interaction control unit 15 divides the score into levels of a high level, a medium level, and a low level. The interaction control unit 15 restricts the interaction in a stepwise manner according to the level of the score. A criteria for classification into the levels can be appropriately set by the system developer.

For example, when the score is at the high level, the interaction control unit 15 does not restrict the interaction. When the score is at the medium level, the interaction control unit 15 inhibits inquiry to the user US, as the restriction on the interaction. When the score is at the low level, the interaction control unit 15 inhibits inquiry and information provision to the user US, as the restriction on the interaction.

For example, the response characteristic of the user US is scored on the basis of the response history at the start of a session. In an identical session, the interaction control unit 15 does not change the restriction on the interaction set at the start of the session. The session means a period of a series of procedures repeated in an interactive manner by using requests and responses. A procedure of notification and browsing of update information upon activation of the system, a procedure of notification and browsing of the latest game title information upon activation of the game, and the like each establish one session. For example, the session is a continuous period from activation to termination of the voice assistant VA.

### 2-1-7. Information Presentation Unit

The information presentation unit 16 presents various types of information to the user US by video and voice. The information presentation unit 16 is configured as a control device that controls a video/audio device such as a television. The information presentation unit 16 may include the video/audio device to be controlled. The information presentation unit 16 performs interaction with the user US with a tone adjusted by the interaction control unit 15 to match the response preference of the user US.

### 2-2. Server

The server 20 analyzes the response data and the context information acquired from the client terminal 10. The server 20 calculates the score of the response characteristic reflecting the response preference of the user US, on the basis of an analysis result. For example, the server 20 includes a data storage unit 21, the scoring unit 22, a data reception unit 23, and a data transmission unit 24.

### 2-2-1. Data Storage Unit

The data storage unit 21 accumulates the response data and the context information that are sequentially acquired from the client terminal 10. The data storage unit 21 stores the accumulated time-series data as the response history of the user US.

### 2-2-2. Scoring Unit

The scoring unit 22 calculates the score of the response characteristic of the user US on the basis of the response history of the user US. For example, the scoring unit 22 is operable to calculate the score on the basis of the presence/absence of the response from the user US to an inquiry. Furthermore, the scoring unit 22 is operable to calculate the score on the basis of a time from the inquiry to the response.

A response status of the user US changes depending on the context (such as the situation of the user US) upon response. Even if the same inquiry or the like is made, response is made difficult when the user US is immersed in the game, chat, or the like. When the response characteristic is determined only by the response data, an accurate determination result is not necessarily obtained. Therefore, the scoring unit 22 varies calculation criteria for the score for the response characteristic according to the context upon response.

In occurrence of the unusual event such as the absence of the user, appropriate response data matching the response characteristic of the user US cannot be obtained. Therefore, the scoring unit 22 performs calculation excluding such inappropriate response data. For example, the scoring unit 22 identifies, as an unusual period, a period in which the unusual event occurs, and calculates the score by selectively using the response data from the user US in a period other than the unusual period.

The response data from the user US identified as the registered user on the basis of the user identification information is transmitted to the server 20. The scoring unit 22 selectively uses the response data from the user US identified as the registered user to calculate the score. The response data includes the verbal information extracted from the content of remarks of the user US and the non-verbal information extracted from the expression and the motion of the user US. The scoring unit 22 calculates the score on the basis of the verbal information and the non-verbal information that are acquired as the response from the user US.

### 2-2-3. Data Transmission Unit and Data Reception Unit

The data transmission unit 24 and the data reception unit 23 are connected to the client terminal 10 via the network NW. The data reception unit 23 receives the response data and the context information that are transmitted from the client terminal 10, and outputs the response data and the context information to the data storage unit 21. The data transmission unit 24 transmits the score of the response characteristic calculated by the scoring unit 22 to the client terminal 10.

### 3. Interaction Example

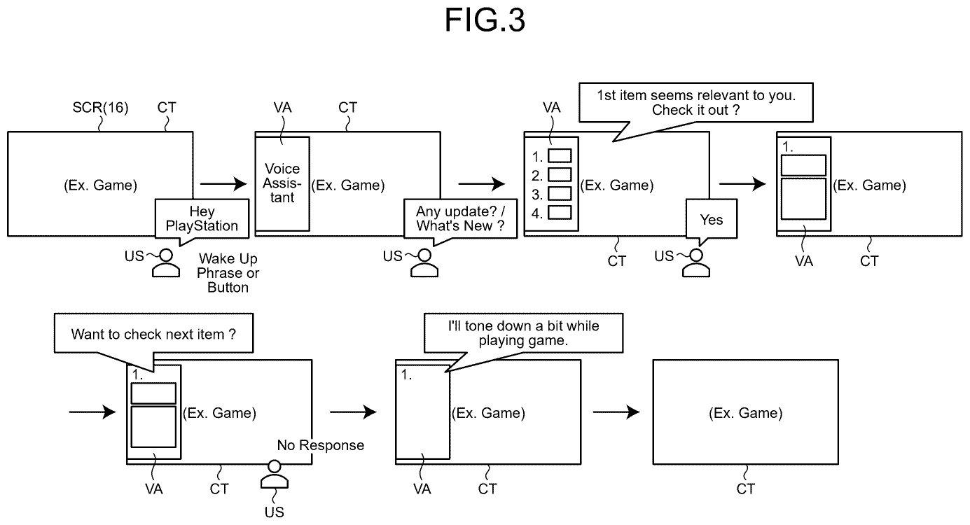

FIG. 3 is a diagram illustrating an example of interaction.

In the example of FIG. 3, a procedure of selecting and browsing the update information is performed in an interactive manner upon activation of the game. First, the user US activates the voice assistant VA by using an activation phrase (e.g., “Hey PlayStation”). The text and video from the voice assistant VA are displayed overlaid on a game screen SCR. The activation of the voice assistant VA may be performed by using an activation button.

The user US inquires of the voice assistant VA about the presence/absence of the update information (e.g., “Any update?” or “What's New?”). The voice assistant VA searches the network NW for the update information in response to the inquiry from the user US, and overlays a result of the search on the game screen SCR.

The voice assistant VA notifies the user US of the most relevant update information from the displayed several pieces of update information, and inquires of the user US whether to browse (e.g., “1st item seems relevant to you. Check it out?”). The user US answers whether to browse, in response to the inquiry from the voice assistant VA (e.g., “Yes”). The voice assistant VA displays target update information on the game screen SCR, in response to a request from the user US.

The voice assistant VA inquires of the user US whether to browse other update information (e.g., “Want to check next item?”). The user US ignores the inquiry from the voice assistant VA with making no response.

When no response continues for a certain period of time, the voice assistant VA determines that there is no response from the user US. The voice assistant VA performs processing of changing the tone in the interaction and notifies the user US of the change of the tone (e.g., “I'll tone down a bit while playing game”). The agent system 1 determines that the user US does not intend to continue the procedure of browsing, and finishes the voice assistant VA.

The voice assistant VA monitors the response from the user US and scores the response characteristic. The change of the tone in the interaction is achieved as a result of change of the score and control of the interaction based on the changed score (e.g., control of an amount of inquiry to the user US). When there is no response, the score is changed to reduce the amount of inquiry, but when the unusual event in which the user US is unable to respond occurs, the score is not changed.

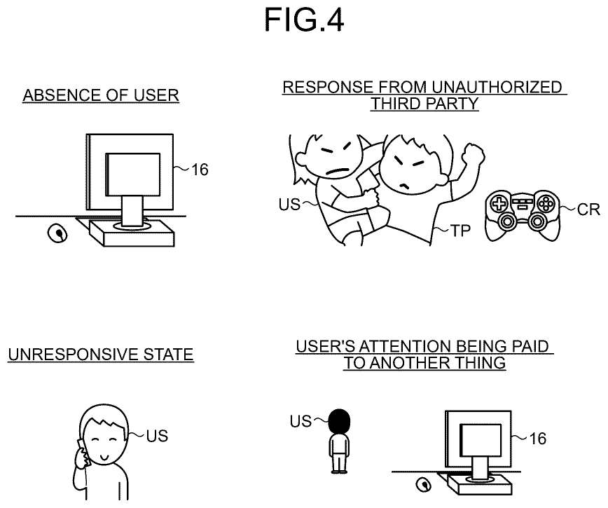

FIG. 4 is a diagram illustrating examples of the unusual event in which the user US is unable to respond.

In FIG. 4, four cases are illustrated as examples of the unusual event. A first case is a case where the user US temporarily leaves the seat. A second case is an unresponsive case due to telephone correspondence or the like. A third case is a case where an unauthorized third party TP (a user other than the registered user who has logged in) is making a response. A fourth case is a case where the user US pays attention to another thing.

The response detection unit 14 detects the unusual event on the basis of the sensor information acquired from the camera, the microphone, the fingerprint sensor, or the like. For example, analyzing a camera image by a known image analysis technique enables detection of the first case, the second case, and the fourth case, and analyzing the voiceprint of a voice collected by the microphone or a fingerprint detected by the fingerprint sensor by a known voice authentication technology or a fingerprint authentication technology enables detection of the third case. Note that the unusual event is not limited to the examples illustrated in FIG. 4. The system developer is allowed to appropriately set whether to detect what situation as the unusual event.

### 4. Score Management

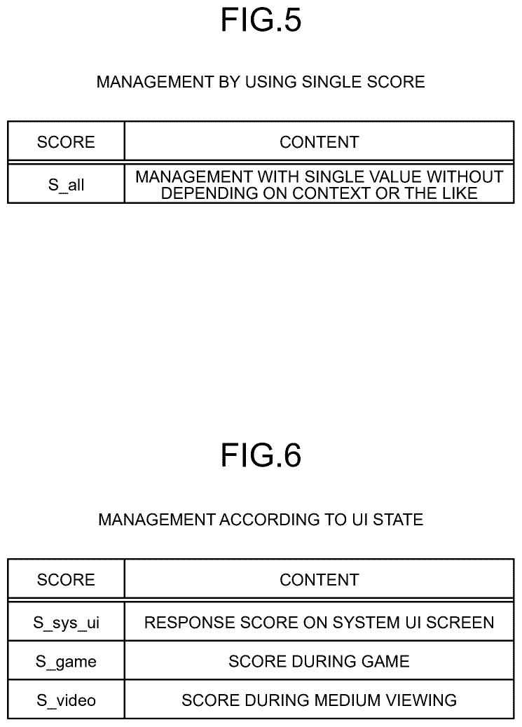

FIGS. 5 to 8 are diagrams each illustrating an example of score management.

The score is calculated on the basis of a preset calculation criterion. For example, when the user US responds to the inquiry from the voice assistant VA, points are added to the score, and when the user US makes no response, points are subtracted from the score. Whether to add or reduce the points in what case or to what extent is defined in the calculation criterion. Common calculation criterion may be used in all situations, but different calculation criteria may be used for different contexts. The agent system 1 is configured to have a plurality of scores associated with different contexts.

FIG. 5 illustrates an example in which the common calculation criterion is used for all situations. A score S_all is determined only on the basis of the response data. Even if the context or the situation of the user US is different, the same score is calculated when the same response data is provided.

FIG. 6 illustrates an example in which the score is managed for each piece of the viewing content. The score calculation criterion is set for each piece of the viewing content. Even if the same response data is used, a different score is calculated when a different piece of the viewing content is provided. In the example of FIG. 6, a response score S_sys_ui on a system UI screen, a score S_game during the game, and a score S_video during medium viewing are illustrated as the scores managed according to different calculation criteria. In addition to this, another response score on a voice chat screen may be prepared, or different response scores may be prepared according to a degree of immersion in the game or chat. The degree of immersion can be determined from controller operation, a distance between the user US and the game screen SCR, a content of voice chat, or the like.

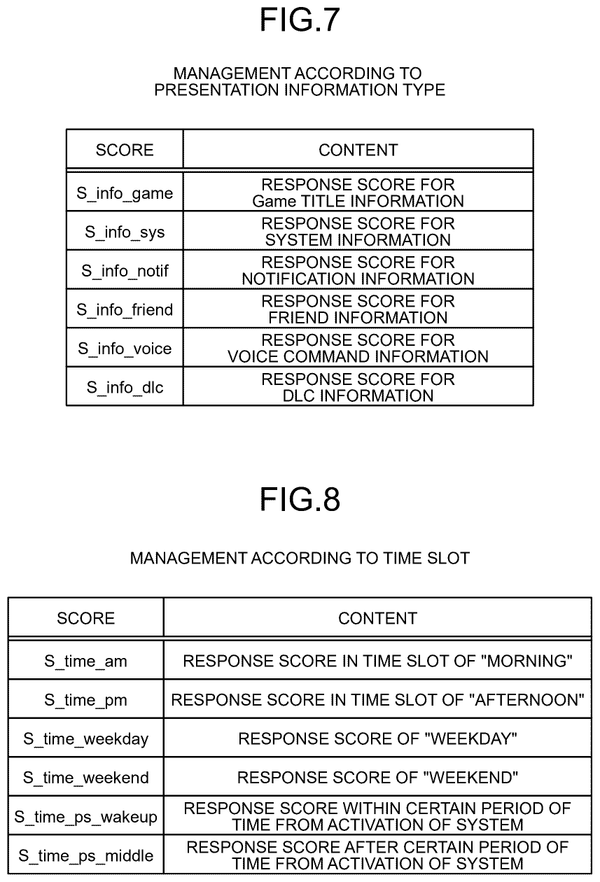

FIG. 7 illustrates an example in which the score is managed for each type of presentation information. The score calculation criterion is set for each type of the presentation information. Even if the same response data is used, a different score is calculated when a different piece of presentation information is provided. In the example of FIG. 7, a response score S_info_game for the game title information, a response score S_info_sys for system information, a response score S_info_notif for notification information, a response score S_info_friend for friend information, a response score S_info_voice for voice command information, and a response score S_info_dlc for download content (DLC) information are illustrated as examples of the scores managed according to different calculation criteria.

FIG. 8 illustrates an example in which the score is managed for each time slot where the interaction is performed. The score calculation criterion is set for each time slot. Even if the same response data is used, a different score is calculated when the time slot is different. In the example of FIG. 8, a response score S_time_am in a time slot of “morning”, a response score S_time_pm in a time slot of “afternoon”, a response score S_time_weekday of “weekday”, a response score S_time_weekend of “weekend”, a response score S_time_ps_wakeup within a certain period of time from the activation of the system, and a response score S_time_ps_middle after the lapse of a certain period of time from the activation of the system are illustrated as examples of the scores managed according to different calculation criteria.

The score represents a degree of expectation of the user US for the inquiry or the information presentation (degree of interest in the interaction). Therefore, the score can be treated as a numerical value indicating the probability that the user US permits the inquiry or the information presentation. In the agent system 1, the score calculation criterion is set so that the score increases as positive response data is obtained.

In actual interaction, a plurality of contexts may be compositely detected. In the composite detection, the interaction control unit 15 enables integration of individual scores associated with each other to control the interaction on the basis of the score (integrated score) obtained by the integration. The integrated score can be calculated, for example, by obtaining a sum of scores to which predetermined weights are added. The weights are configured to be set in advance for the respective contexts.

### 5. Example of Inquiry and Information Presentation

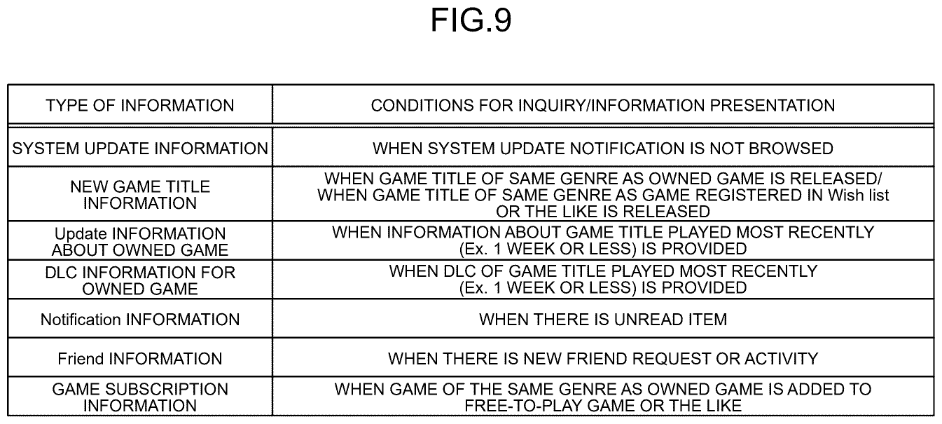

FIG. 9 is a table illustrating an example of conditions for the inquiry and the information presentation.

The voice assistant VA enables not only the information presentation in response to the inquiry or the request from the user US, but also active inquiry or information presentation to the user US by itself. The inquiry or information presentation by itself is made when a predetermined condition is satisfied. FIG. 9 illustrates seven types as examples of inquiry and information provision by the voice assistant VA itself.

For example, the voice assistant VA determines whether to present system update information on the basis of a browsing state of the user US in the past. When it is determined that the user US has not yet browsed the latest notification about the system update, from the browsing state in the past, the voice assistant VA inquires of the user US whether to browse. When receiving a request for browsing from the user US, the voice assistant VA presents the system update information.

The voice assistant VA determines whether to present new game title information, on the basis of information such as a title of a game or a wish list owned by the user US. When a game of the same genre as the game owned by the user US or a game of the same genre as a game registered in the wish list or the like is released, the voice assistant VA inquires of the user US whether to browse. When receiving a request for browsing from the user US, the voice assistant VA presents target game title information.

The voice assistant VA determines whether to present the update information about the owned game, on the basis of the latest gameplay state of the user US. When there is update information about a game having been recently played (e.g., a game played within one week) by the user US, the voice assistant VA inquires of the user US whether to browse. When receiving a request for browsing from the user US, the voice assistant VA presents the update information about a target game.

The voice assistant VA determines whether to present the DLC information about the owned game, on the basis of the latest gameplay state of the user US. When there is DLC information about the game having been recently played (e.g., the game played within one week) by the user US, the voice assistant VA inquires of the user US whether to browse. When receiving a request for browsing from the user US, the voice assistant VA presents the DLC information about a target game.

The voice assistant VA determines whether to present the notification information on the basis of the presence/absence of an unread item. When there is the unread item, the voice assistant VA inquires of the user US whether to browse. When receiving a request for browsing from the user US, the voice assistant VA presents the unread item.

The voice assistant VA determines whether to present the friend information on the basis of the presence/absence of a new friend request or activity of the friend. The friend information includes information about a user who has made the friend request and information about the activity of the user registered as the friend. When there is the new friend request or activity, the voice assistant VA inquires of the user US whether to browse the friend information. When receiving a request for browsing from the user US, the voice assistant VA presents the friend information.

The voice assistant VA determines whether to present game subscription information on the basis of information such as a free-to-play game. The free-to-play game means a special benefit of a paid subscription service for playing some of delivered games at no extra charge. When a game of the same genre as the game owned by the user US is added to the free-to-play game or the like, the voice assistant VA inquires of the user US whether to browse. When receiving a request for browsing from the user US, the voice assistant VA presents the game subscription information.

Note that, when presentation conditions for a plurality of pieces of information are simultaneously detected, all of the plurality of pieces of information may be presented to the user US, or one piece of information may be selected for presentation to the user US. When the number of pieces of presentation information is limited to one, information having a higher score may be preferentially selected.

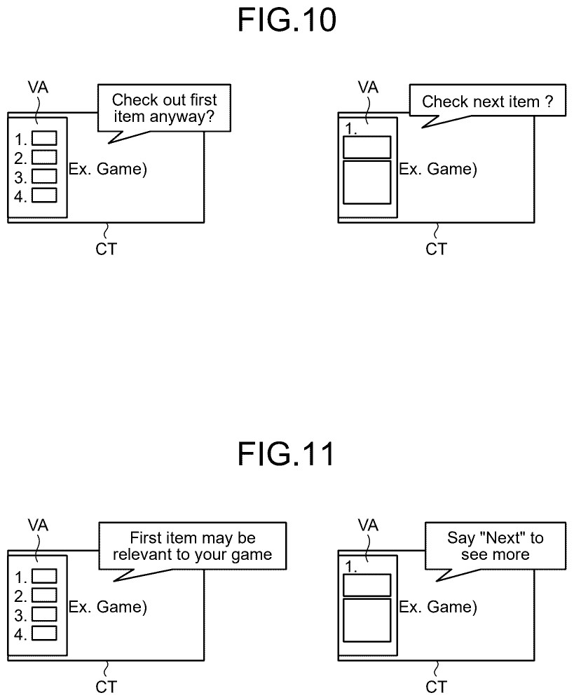

FIG. 10 is diagrams illustrating an example of inquiries to the user US. FIG. 11 is diagrams illustrating an example of information presentation to the user US.

A method for inquiry or information presentation can be appropriately set by the system developer. The inquiry may be made and the information may be presented only by text or voice, or with the non-verbal information such as eye contact or gesture by an avatar.

Various methods can also be adopted for selection of the presentation information. For example, in the example of FIG. 10, information to be browsed is determined by the user US through spoken dialogue. In the example of FIG. 11, priority of browsing is automatically determined by the system, and is presented in descending order of priority while obtaining permission of the user US. Note that the method of selecting the presentation information and voice of the system prompting the selection are not limited to those illustrated in FIGS. 10 and 11.

### 6. Process Procedure

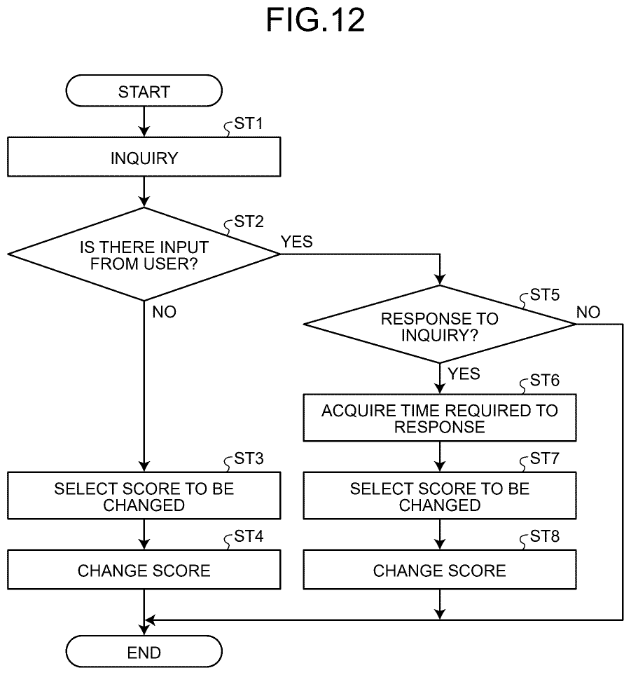

FIG. 12 is a flowchart illustrating an exemplary process procedure for scoring.

The voice assistant VA makes an inquiry to the user US (Step ST1). The response detection unit 14 determines whether there is an input from the user US (Step ST2). When there is no input from the user US (Step ST2: No), the scoring unit 22 selects a score to be changed, on the basis of the context information (Step ST3). The scoring unit 22 changes the selected score, on the basis of the calculation criterion represented by the following Formula (1) (Step ST4), and finishes the process.

$$S = S - C \times step \qquad ( 1 )$$

In Formula (1), “S” represents a score. “C” represents a constant. “step” represents a coefficient set for each context.

When there is an input from the user US (Step ST2: Yes), the response detection unit 14 determines whether the input is a response to the inquiry (Step ST5). When the input is the response to the inquiry (Step ST5: Yes), the scoring unit 22 acquires a time from the inquiry to the response (Step ST6). The scoring unit 22 selects a score to be changed on the basis of the context information (Step ST7). The scoring unit 22 changes the selected score, on the basis of the calculation criterion represented by the following Formula (2) (Step ST8), and finishes the process.

$$S = S + C \times step \times 1 / Tr \qquad ( 2 )$$

In Formula (2), “Tr” represents a time required to the response, acquired in Step ST6.

When the input is not a response to the inquiry (Step ST5: No), the scoring unit 22 finishes the process without changing the score.

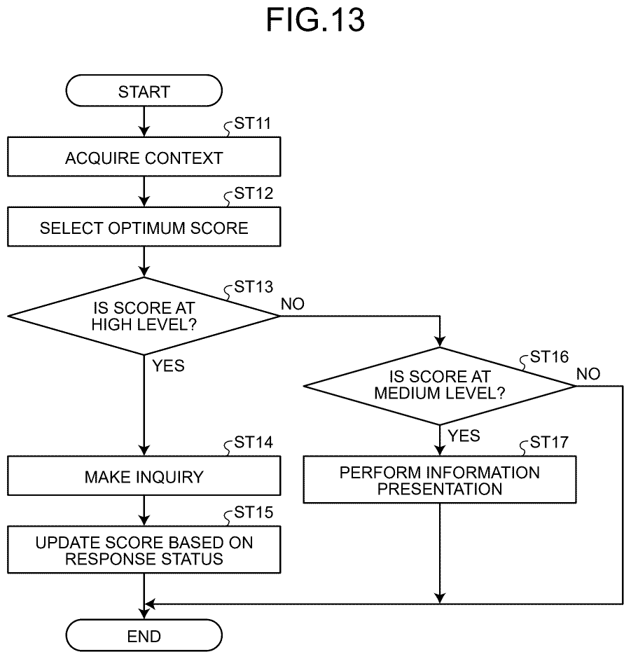

FIG. 13 is a flowchart illustrating an exemplary process procedure for restriction on the interaction.

The scoring unit 22 acquires the context information from the client terminal 10 (Step ST11). The scoring unit 22 selects a specific score associated with the context (Step ST12). The scoring unit 22 calculates the score on the basis of the calculation criterion according to the context and transmits the score to the client terminal 10.

The interaction control unit 15 determines whether the score is at the high level (Step ST13). When the score is at the high level (Step ST13: Yes), the interaction control unit 15 makes an inquiry to the user US (Step ST14). The scoring unit 22 updates the score on the basis of the response status of the user US to the inquiry (Step ST15).

When the score is not at the high level (Step ST13: No), the interaction control unit 15 determines whether the score is at the medium level (Step ST16). When the score is at the medium level (Step ST16: Yes), the interaction control unit 15 performs information presentation to the user US (Step ST17). When the score is not at the medium level (Step ST16: No), the interaction control unit 15 inhibits the inquiry and the information presentation to the user US.

### 7. Modifications

Hereinafter, modifications of the above-described embodiments will be described.

### 7-1. First Modification

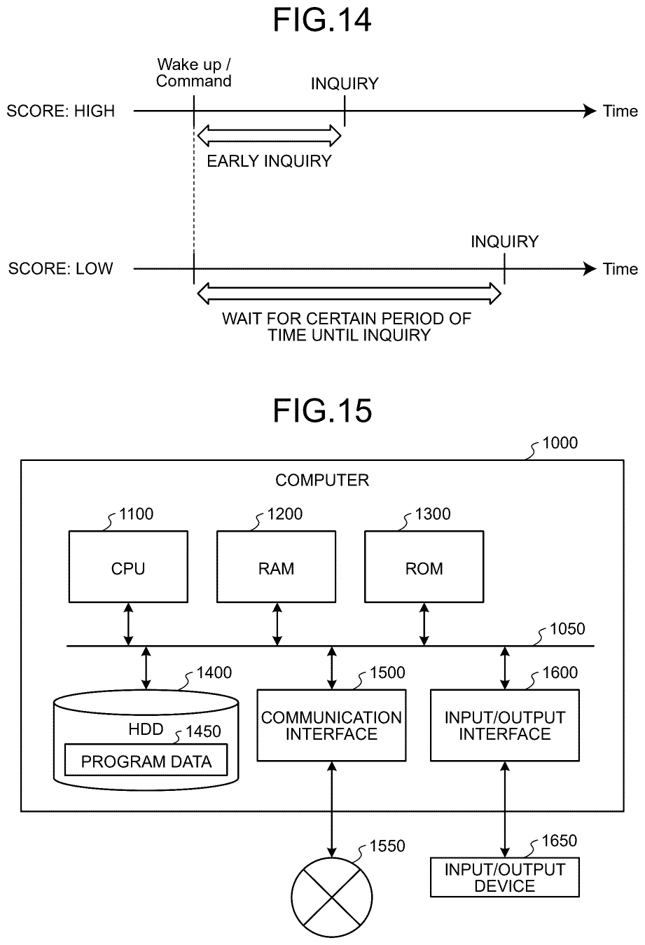

FIG. 14 is a diagram illustrating a modification of control of the interaction. In the above-described embodiments, the interaction control unit 15 has changed the amount of inquiry on the basis of a corresponding score. However, the control of the interaction is not limited to the control of the amount of inquiry. The interaction control unit 15 may change the timing of inquiry, according to the score.

For example, a time from when the voice assistant VA is activated (or after the user US inputs a command to the voice assistant VA) to when the voice assistant VA makes an inquiry to the user US is defined as an approach time. In the example of FIG. 14, the approach time is set to be shorter when the score is at the high level, and the approach time is set to be longer when the score is at the low level.

The score reflects the degree of interest of the user US in the interaction. The higher the score, the higher the interest of the user US in the interaction. Therefore, the approach time is set shorter as the score is higher. As a result, the inquiry and the response are made at a good pace, and comfortable interaction matching the response preference of the user US is achieved.

### 7-2. Second Modification

In the example of FIG. 13, the inquiry and the information provision by the voice assistant VA has been restricted in a stepwise manner. However, the restriction on the interaction is not limited thereto. For example, the method of the present disclosure can also be applied to a process of determining whether which character's voice is to be set as a text to speech (TTS) voice.

For example, when the score is at the high level, the interaction control unit 15 causes the user US to determine a character for voice through dialogue. When the score is at the low level, the interaction control unit 15 automatically assigns a character's voice frequently used by the user US without a dialogue with the user US.

The method of the present disclosure can also be applied to a process of determining whether to reproduce video content. For example, when the score is at the high level, the interaction control unit 15 causes the user US to determine whether to reproduce the video content, through dialogue. When the score is at the low level, the interaction control unit 15 automatically determines whether to reproduce the video content, on the basis of the tendency of behavior of the user US acquired in advance without a dialogue with the user US. For example, for the user US having a high probability of viewing the video content, the video content is configured to be automatically reproduced without depending on the dialogue.

Similarly, the method of the present disclosure can also be applied to a process of determining whether to make a transition to “next content”. For example, when the user US tends to frequently view the “next content” and the score is at the low level, the interaction control unit 15 is configured to automatically transition to the “next content” without depending on the dialogue.

### 7-3. Third Modification

In the example of FIG. 3, the agent system 1 of the present disclosure has been applied to a game console. However, the agent system 1 of the present disclosure can be applied to various devices other than the game console. For example, the agent system 1 is configured to be mounted on an in-vehicle system to select and browse restaurant information, cafe information, and the like through spoken dialogue.

The agent system 1 is also configured to be mounted on a television or a video content device for a streaming service or the like to determine the type of video content to be viewed and the like through spoken dialogue. Furthermore, the agent system 1 is configured to be mounted on a home robot (such as a cleaning robot) to select and perform various processing through spoken dialogue. Furthermore, the agent system 1 can also be applied to communication using an avatar (virtual store, or virtual chat such as massively multiplayer online (MMO)).

### 8. Exemplary Hardware Configuration

FIG. 15 is a diagram illustrating an exemplary hardware configuration of the information processing device PD.

The information processing in the information processing device PD is implemented by, for example, a computer 1000. The computer 1000 includes a central processing unit (CPU) 1100, a random access memory (RAN) 1200, a read only memory (ROM) 1300, a hard disk drive (HDD) 1400, a communication interface 1500, and an input/output interface 1600. The respective units of the computer 1000 are connected by a bus 1050.

The CPU 1100 operates on the basis of a program (program data 1450) stored in the ROM 1300 or the HDD 1400, and controls each unit. For example, the CPU 1100 loads a program stored in the ROM 1300 or the HDD 1400 into the RAM 1200, and performs processing corresponding to each of various programs.

The ROM 1300 stores a boot program, such as a basic input output system (BIOS), executed by the CPU 1100 when the computer 1000 is booted, a program depending on hardware of the computer 1000, and the like.

The HDD 1400 is a computer-readable non-transitory recording medium that non-transitorily records a program executed by the CPU 1100, data used by the program, and the like. Specifically, the HDD 1400 is a recording medium that records, as an example of the program data 1450, an information processing program according to an embodiment.

The communication interface 1500 is an interface for connecting the computer 1000 to an external network 1550 (e.g., the Internet). For example, the CPU 1100 receives data from another device or transmits data generated by the CPU 1100 to another device, via the communication interface 1500.

The input/output interface 1600 is an interface for connecting an input/output device 1650 and the computer 1000. For example, the CPU 1100 receives data from an input device such as a keyboard or mouse via the input/output interface 1600. In addition, the CPU 1100 transmits data to an output device such as a display device, speaker, or printer via the input/output interface 1600. Furthermore, the input/output interface 1600 may function as a media interface that reads a program or the like recorded on a predetermined recording medium. The medium includes, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, when the computer 1000 functions as the information processing device PD according to an embodiment, the CPU 1100 of the computer 1000 executes the information processing program loaded into the RAM 1200 to implement the function of each unit described above. In addition, the HDD 1400 stores the information processing program, various models, and various data according to the present disclosure. Note that the CPU 1100 executes the program data 1450 read from the HDD 1400, but in another example, the CPU 1100 may acquire these programs from another device via the external network 1550.

### 9. Effects

The information processing device PD includes the scoring unit 22 and the interaction control unit 15. The scoring unit 22 calculates a score of a response characteristic of the user US, on the basis of a response history of the user US in the interaction with the user US. The interaction control unit 15 controls the amount of inquiry to the user US in the interaction, on the basis of the score. In an information processing method of the present disclosure, processing in the information processing device PD is executed by the computer.

According to this configuration, the interaction suitable for the response preference of the user US is controlled. Therefore, the comfortable interaction as expected by the user US is achieved.

The scoring unit 22 calculates the score on the basis of the presence/absence of a response from the user US to an inquiry.

According to this configuration, an appropriate score reflecting the response status of the user US is calculated.

The scoring unit 22 calculates the score on the basis of a time from the inquiry to the response.

According to this configuration, an appropriate score reflecting the response status of the user US is calculated.

The information processing device PD includes the response detection unit 14. The response detection unit 14 detects the unusual event in which the user US is unable to respond. The scoring unit 22 calculates the score by selectively using the response data from the user US in a period other than the period in which the unusual event occurs.

According to this configuration, an appropriate score reflecting the response status of the user US is calculated.

The scoring unit 22 varies calculation criteria for the score according to the context upon response.

According to this configuration, the score is calculated in consideration of the context upon response. Analyzing the response characteristic in consideration of the context, the appropriate score is calculated.

The context includes the type of content being viewed by the user US, the type of information presented to the user US, or the time slot in which the interaction is performed.

The viewing content and the like upon response may greatly affect the response characteristic of the user US. Therefore, consideration of these pieces of information enables appropriate control of the interaction.

The interaction control unit 15 restricts the interaction on the basis of the score.

According to this configuration, a burden of the response is appropriately reduced according to the response preference of the user US.

The interaction control unit 15 divides the score into a level. The interaction control unit 15 restricts the interaction in a stepwise manner according to the level of the score.

This configuration makes it possible to finely respond to the response preference of the user US.

When the score is at the high level, the interaction control unit 15 does not restrict the interaction. When the score is at the medium level, the interaction control unit 15 inhibits inquiry to the user US, as the restriction on the interaction. When the score is at the low level, the interaction control unit 15 inhibits inquiry and information provision to the user US, as the restriction on the interaction.

According to this configuration, the burden of the response is appropriately reduced according to the level of the score.

The interaction control unit 15 changes the timing of inquiry, according to the score.

This configuration makes it possible to make an inquiry with an appropriate rhythm according to the response preference of the user US.

In an identical session, the interaction control unit 15 does not change the restriction on the interaction set at the start of the session.

This configuration makes it possible to stabilize the tone in the interaction.

The scoring unit 22 calculates the score on the basis of the verbal information and the non-verbal information that are acquired as the response from the user US.

According to this configuration, the response preference of the user US is accurately identified on the basis of both the verbal information and the non-verbal information.

The information processing device PD includes the user identification unit 13. The user identification unit 13 identifies the user US. The scoring unit 22 selectively uses the response data from the user US identified as the registered user to calculate the score.

This configuration makes it possible to accurately calculate the score on the basis of only the response data from the registered user.

The information processing device PD includes the data transmission unit 17, the data reception unit 18, and the interaction control unit 15. The data transmission unit 17 transmits the response data from the user US acquired in the interaction with the user US. The data reception unit 18 receives the score of the response characteristic of the user US calculated on the basis of the response history of the user US. The interaction control unit 15 controls the amount of inquiry to the user US in the interaction, on the basis of the score. In the information processing method of the present disclosure, processing in the information processing device PD is executed by the computer.

According to this configuration, the interaction suitable for the response preference of the user US is controlled. Therefore, the comfortable interaction as expected by the user US is achieved.

Note that the effects described herein are merely examples and are not limited to the descriptions, and other effects may be provided.

### Supplementary Notes

Note that the present technology can also have the following configurations.

(1)

An information processing device comprising:
a scoring unit that calculates a score of a response characteristic of a user based on a response history of the user in interaction with the user; and
an interaction control unit that controls an amount of inquiry to the user in the interaction, based on the score.
   (2)

The information processing device according to (1), wherein
the scoring unit calculates the score based on presence/absence of a response from the user to the inquiry.
   (3)

The information processing device according to (2), wherein
the scoring unit calculates the score based on a time from the inquiry to the response.
   (4)

The information processing device according to any one of (1) to (3) further comprising
a response detection unit that detects an unusual event in which the user is unable to respond, wherein
the scoring unit selectively uses response data from the user in a period other than a period in which the unusual event occurs to calculate the score.
   (5)

The information processing device according to any one of (1) to (4), wherein
the scoring unit varies calculation criteria for the score according to a context upon response.
   (6)

The information processing device according to (5), wherein
the context includes a type of content being viewed by the user, a type of information presented to the user, or a time slot in which the interaction is performed.
   (7)

The information processing device according to any one of (1) to (6), wherein
the interaction control unit restricts the interaction based on the score.
   (8)

The information processing device according to (7), wherein
the interaction control unit divides the score into a level, and restricts the interaction in a stepwise manner according to the level of the score.
   (9)

The information processing device according to (8), wherein
the interaction control unit
does not restrict the interaction when the score is at a high level,
inhibits the inquiry to the user, as the restriction on the interaction, when the score is at a medium level, and
inhibits the inquiry and information provision to the user, as the restriction on the interaction, when the score is at a low level.
   (10)

The information processing device according to any one of (7) to (9), wherein
the interaction control unit changes timing of inquiry according to the score.
   (11)

The information processing device according to any one of (7) to (10), wherein
the interaction control unit does not change the restriction on the interaction set at the start of session, in an identical session.
   (12)

The information processing device according to any one of (1) to (11), wherein
the scoring unit calculates the score based on verbal information and non-verbal information that are acquired as a response from the user.
   (13)

The information processing device according to any one of (1) to (12), further comprising
a user identification unit that identifies the user, wherein
the scoring unit selectively uses response data from the user identified as a registered user to calculate the score.
   (14)

An information processing device comprising:
a data transmission unit that transmits response data from a user in interaction with the user;
a data reception unit that receives a score of a response characteristic of the user calculated based on a response history of the user; and
an interaction control unit that controls an amount of inquiry to the user in the interaction, based on the score.
   (15)

An information processing method executed by a computer, the method comprising:
calculating a score of a response characteristic of a user based on a response history of the user in interaction with the user; and
controlling an amount of inquiry to the user in the interaction, based on the score.
   (16)

An information processing method executed by a computer, the method comprising:
transmitting response data from a user in interaction with the user;
receiving a score of a response characteristic of the user calculated based on a response history of the user, and
controlling an amount of inquiry to the user in the interaction, based on the score.

### REFERENCE SIGNS LIST

10 CLIENT TERMINAL (INFORMATION PROCESSING DEVICE)
13 USER IDENTIFICATION UNIT
14 RESPONSE DETECTION UNIT
15 INTERACTION CONTROL UNIT
17 DATA TRANSMISSION UNIT
18 DATA RECEPTION UNIT
PD INFORMATION PROCESSING DEVICE
US USER

1. An information processing device comprising:
a scoring unit that calculates a score of a response characteristic of a user based on a response history of the user in interaction with the user; and
an interaction control unit that controls an amount of inquiry to the user in the interaction, based on the score.

2. The information processing device according to claim 1, wherein
the scoring unit calculates the score based on presence/absence of a response from the user to the inquiry.

3. The information processing device according to claim 2, wherein
the scoring unit calculates the score based on a time from the inquiry to the response.

4. The information processing device according to claim 1 further comprising
a response detection unit that detects an unusual event in which the user is unable to respond, wherein
the scoring unit selectively uses response data from the user in a period other than a period in which the unusual event occurs to calculate the score.

5. The information processing device according to claim 1, wherein
the scoring unit varies calculation criteria for the score according to a context upon response.

6. The information processing device according to claim 5, wherein
the context includes a type of content being viewed by the user, a type of information presented to the user, or a time slot in which the interaction is performed.

7. The information processing device according to claim 1, wherein
the interaction control unit restricts the interaction based on the score.

8. The information processing device according to claim 7, wherein
the interaction control unit divides the score into a level, and restricts the interaction in a stepwise manner according to the level of the score.

9. The information processing device according to claim 8, wherein
the interaction control unit
does not restrict the interaction when the score is at a high level,
inhibits the inquiry to the user, as the restriction on the interaction, when the score is at a medium level, and
inhibits the inquiry and information provision to the user, as the restriction on the interaction, when the score is at a low level.

10. The information processing device according to claim 7, wherein
the interaction control unit changes timing of inquiry according to the score.

11. The information processing device according to claim 7, wherein
the interaction control unit does not change the restriction on the interaction set at the start of session, in an identical session.

12. The information processing device according to claim 1, wherein
the scoring unit calculates the score based on verbal information and non-verbal information that are acquired as a response from the user.

13. The information processing device according to claim 1, further comprising
a user identification unit that identifies the user, wherein
the scoring unit selectively uses response data from the user identified as a registered user to calculate the score.

14. An information processing device comprising:
a data transmission unit that transmits response data from a user in interaction with the user;
a data reception unit that receives a score of a response characteristic of the user calculated based on a response history of the user; and
an interaction control unit that controls an amount of inquiry to the user in the interaction, based on the score.

15. An information processing method executed by a computer, the method comprising:
calculating a score of a response characteristic of a user based on a response history of the user in interaction with the user; and
controlling an amount of inquiry to the user in the interaction, based on the score.

16. An information processing method executed by a computer, the method comprising:
transmitting response data from a user in interaction with the user;
receiving a score of a response characteristic of the user calculated based on a response history of the user, and
controlling an amount of inquiry to the user in the interaction, based on the score.
